(19) United States
(12) Patent Application Publication
(10) Pub. No.: US 2018/0303287 A1
(43) Pub. Date: Oct. 25, 2018

(54) TEMPERATURE CONTROLLED WATER AND OIL FILTERING DEEP FRYER

(71) Applicant: TKS WINWELL EQUIPMENT SUPPLY SDN BHD, Prai, Pulau Pinang (MY)

(72) Inventor: Tam Kim Seng SEAN, Prai (MY)

(73) Assignee: TKS WINWELL EQUIPMENT SUPPLY SDN BHD, Prai, Pulau Pinang (MY)

(21) Appl. No.: 15/768,651

(22) PCT Filed: Oct. 17, 2016
(86) PCT No.: PCT/MY2016/000065

§ 371 Date: Apr. 16, 2018

(30) Foreign Application Priority Data
Oct. 15, 2015 (MY) UI 2015703700

(51) Int. Cl. A47J 37/12

(52) U.S. Cl. CPC A47J 37/1285; A47J 37/1223; A47J 37/1266

(57) ABSTRACT

The present invention provides a deep fryer that has both oil (101) and water (102) layer in contact with each other to enable fried impurities to sink to the water (102) layer. The fried impurities are filtered out using a mesh filter (131) and the water is pumped back into the water layer (102) after filtration. The temperature is fixed at a default setting, 180° C. The thermocouple will be automatically cut off when there is a drastic increase in the temperature of (oil 101) and water (102) layer. Alarm systems notify the user when the deep fryer is not working correctly. The whole fryer shuts down if there is a fault in the (pump 132) or temperature.

### FIELD OF INVENTION

The present invention describes a deep fryer for frying food and more particularly an apparatus and method of removing the impurities in the deep fryer in a non-labor intensive, and cost-effective and efficient manner.

### BACKGROUND OF INVENTION

Food frying was discovered over thousands of years ago dating back to the 5^{th} millennium. Subsequently, many types of food have been introduced to the frying process ranging from vegetable fritters to seafood fritters. Typically, the act of deep-frying involves plunging food into hot oil at a high temperature where the food remains moist on the inside. Frying impurities act as a catalyst to breakdown the oil used to fry food; but the impurities can degrade the quality of the oil which is typically recycled for future use. Thus, the fried impurities need to be removed to preserve the oil used for frying.

Other problems in relation to conventional deep fryer include oil foaming, oil darkening, oil splattering, greasy food, smoke formation and high oil consumption. This occurs due to excess starch in oil from chips or batter, frying at too high temperature, high moisture content of food, overloading of fryer, soap or detergent left behind after cleaning, breakdown of oil over time, crumbs burning in tank causing carbon suspension and oil in contact with copper or brass. The common liquid that causes the oil splattering is due to the presence of water in the food.

Japanese Patent 2010183971A describes a fryer that has both an oil layer and a water layer, which are in contact with each other. The heating medium is placed in the oil layer while a circulating pipe brings water sucked out from the outlet located at the bottom of the tank through the discharge tube and into a final discharge portion. The water layer is swirled intermittently using a flow of fresh water injected from a supply port at a wall at a lower portion of the container into the water layer. In this prior art, the water control system plays an important part in both the cleaning procedure and the temperature control as well. In comparison, the water filter, pump and circulation pipe for the proposed invention is located inside the container itself compared to the prior art wherein the filter, pump and circulation are attached to the vat as an unconnected or a distinctive water filtering tank.

It is crucial that a deep-frying machine contains features that are able to solve majority of the current issues as discussed above. It would be highly desirable to be able to produce a high-end deep fryer that are able to preserve the durability of the oil while maintaining the quality of the fried food at the same time.

### SUMMARY OF THE INVENTION

The proposed invention describes a deep fryer machine with the ability to control the temperature of both oil 101 and water in the said fryer. In one aspect; the fryer comprises of a container to store water and oil together wherein the oil 101 layer fills 65% of the container whereas the water layer fills 35% of the container. In one embodiment, the deep fryer is inclusive of a heating element that will be placed in ¾ of the oil 101 layer. In a further embodiment, the present invention further comprises a control panel to control the temperature and timer. In yet another embodiment, the temperature of the oil must be higher than water at 160° C.-180° C. and the temperature of water, 47° C.

In a further embodiment of the present invention, there is a mesh filter 131 to remove fried impurities wherein fried impurities formed drop to the bottom of the container and to the mesh filter 131 due to the relative density of fried impurities being higher than water and oil. A pump is placed to allow the water to be cycled back into the water area in the container whereby the water pressure from the water circulation brings the fried impurities down to the mesh filter 131 and out while the water is pumped back through the circulation pipe. The key point in this circulation system is that the recycling of water is auto cut-off if water temperature exceeds 47° C. and thus terminating the heating and then the whole deep fryer system.

### BRIEF DESCRIPTION OF DRAWING

FIG. 1 is an elevation view of a preferred embodiment of a temperature controlled water and oil filtering deep fryer according to an embodiment of the present invention.

### DETAILED DESCRIPTION OF THE INVENTION

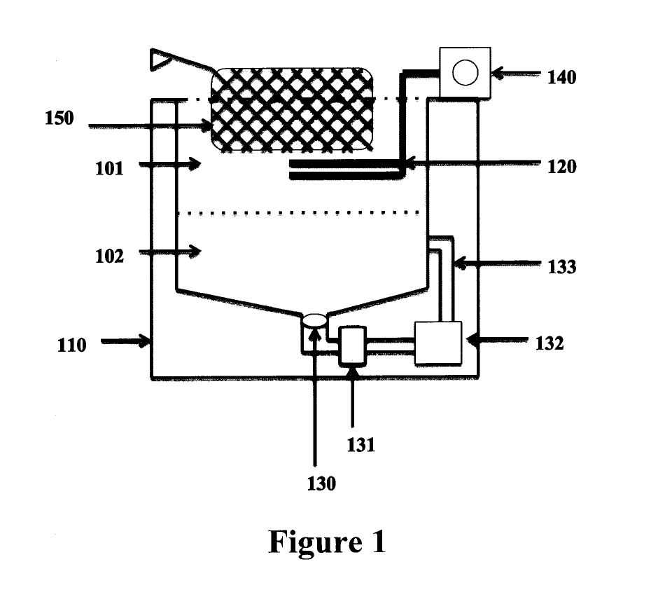

The present invention will be further described by the following detailed description of the embodiments as per illustration in FIG. 1.

The deep fryer of the present invention comprises of a container 110 to store water and oil together; in which the oil fills approximately 65% of the container 110 resulting in the oil to water content ratio to be 65:35 in volume percentage (v/v %). A food holder or basket 150 is inserted into the oil layer 101 when necessary to contain food for frying. The food basket 150 may be made from a material that is able to withstand high temperature. Next, a heating element 120 is placed in ¾ within the oil layer 101; for providing heat to increase the temperature of the oil. The heating element 120 comprises of two thermocouples for temperature setting purpose.

The first thermocouple allows the user to set the desired temperature and the second thermocouple is pre-set at a predetermined temperature; preferably 180° C., as it is sufficient to vaporize the water at the surface of the food. The water creates a small layer of vapor around the food that prevents the oil from entering and making the food oily. The second thermocouple serves as a backup for the first thermocouple. This is to ensure that even if the temperature set by the user is higher than 180° C., and that such increase is detected by the second thermocouple; the second thermocouple is adapted to automatically cut off the heating. This concludes that the temperature of the oil and water subjected to the heating process performed by heating element 120 will not exceed 180° C. This backup thermocouple is a precautionary step to avoid any unforeseen accidents due to the failure of the first thermocouple. When the temperature reaches 180° C., the heating process by heating element 120 is stopped and is switched back on when the temperature reduces.

The water layer 102 covers 35% of the container 110 with a default temperature, 180° C. There may be a level indicator that includes a notifier provided on an inner surface the container 110 for reference purpose. The notifier is adapted to produce a form of an alarm when water level reaches the fixed amount.

In one embodiment, a control panel 140 is built on the deep fryer 100 accordingly configured to control the temperature and timer. The temperature of the oil layer 101 ranges between 160° C.-180° C. and the temperature of the water layer 102 is preferably 47° C. or below. In any situation where the temperature of the water layer 102 exceeds 47° C., the thermocouple is configured to detect such situation and automatically cuts off the heating process.

The deep fryer 100 of the present invention further includes a mesh filter 131. The mesh filter 131 is an important part of this deep fryer 100 that plays a role in removing fried impurities, wherein fried impurities drop onto the mesh filter 131 prior to reaching the bottom of the container; due to the relative density of fried impurities being higher than water and oil. In one embodiment, the mesh filter 131 formed with 150μ stainless steel and is adapted to be a washable mesh filter 131. It can be re-used a few times thus reducing the cost for the mesh filter 131. In the event that the impurities clogs the mesh filter 131 unit, resulting to disrupted water flow, the flow sensor is adapted to detect such disruption and identifies the reason behind the reduction in the flow speed. During this process, the alarm of the indicator is set off. After 30 seconds of alarm of the indicator is set off, the heating element 120 stops the heating process.

Apart from these, the present invention contains a pump 132 that functions to return water back into the water layer 102 in the container 110 through a circulation pipe 133 in the exterior. The pump 132 is adapted to recycle water and reduce the temperature, whereby the circulation of water reduces the temperature of the water in the water layer 102. The pump 132 is to enable the water with fried impurities to be pumped out from the discharge outlet 130 through the circulation pipe 133 to the mesh filter 131 and back to the water layer 102 in the container 110. The water is continuously rotated and is cut-off automatically if the temperature exceeds 47° C. or whole the deep fryer 100 is turned off. The pump 132 is operated in a way where if found to be faulty, the deep fryer 100 stops functioning entirely until the pump 132 is fixed. The pump 132 may be built with a sensor system (not shown) that is able to detect the flow status of the water. It will set the alarm on if the flow of the water in the circulation pipe 133 is low. In a case where the alarm fails to be set on, the pump 132 is equipped with a display means to show the temperature for manual monitoring.

The control panel 140 may have a timer setting at 10 min, 15 min and 25 min. It is however anticipated that the timer may be set at differing periods of time that are suitable to achieve the intended objects of the present invention. When the predetermined heating time is up, the heating element 120 stops the heating process. However, the pump 132 will still be switched on for about 5 min to 8 min before it switches off the whole fryer system. There is an alarm to indicate if the timer has been set off. It is important to have a timer system that suits is stopped when time is up. This is important as prolonged heating of oil will result in oil degradation, oil darkening and smoke formation.

According to another embodiment of the present invention, the deep fryer 100 can be made from stainless steel in order to avoid corrosions and interaction with the oil used.

As would be apparent to a person having ordinary skilled in the art, the afore-described methods and components may be provided in many variations, modifications or alternatives to existing methods and systems. The principles and concepts disclosed herein may also be implemented in various manner which may not have been specifically described herein but which are to be understood as encompassed within the scope and letter of the following claims.

1. A fryer comprising:
a container for containing water and oil together comprising at least one outlet 130 that channels frying impurities to a mesh filter 131 for removal of impurities and a circulation pipe 133 for circulation of water back;
a heating element 120 for providing heat; placed in ¾ of oil 101 area,
a control panel 140 to control the temperature and timer;
wherein the temperature of the oil is higher than water at a range of 160° C.180° C. and water, at a maximum temperature of 47° C.;
a circulation pipe 133 for channeling water from the outlet 130 to the mesh filter 131 and to the pump 132 before returning the water into the water layer 102;
a mesh filter 131 for filtering impurities in the water layer; located along the circulation pipe 133;
a pump 132 for channeling and pumping water into the water layer 102 in the container through a circulation pipe 133; located along the circulation pipe 133 after the mesh filter 131;
wherein the oil to water content ratio is 65:35 in volume percentage (v/v %);
wherein the water circulation and relative density of fried impurities results to the fried impurities to move downwardly through the outlet 130 to the mesh filter 131 and disposed out from the container while the water is pumped back by the pump 132 through the circulation pipe 133; and
wherein recycling of water flow is cut-off automatically if water temperature exceeds 47° C.
